(19) United States
(12) Patent Application Publication
(10) Pub. No.: US 2011/0008011 A1
(43) Pub. Date: Jan. 13, 2011

(54) FIBER DROP INSTALLATION DEVICE

(75) Inventor: Patrick Allen Weaver, Baden, PA (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING, INC., Basking Ridge, NJ (US)

(21) Appl. No.: 12/499,883

(22) Filed: Jul. 9, 2009

(51) Int. Cl. G02B 6/00

(52) U.S. Cl. 385/134

(57) ABSTRACT

An optical fiber installation device may include a device for receiving a fiber optic drop fed thereto. A drop stop element may be configured to attach to the fiber optic drop at a particular position. The device may be configured to engage the drop stop element to inhibit feeding of additional fiber optic drop to the device.

### BACKGROUND

In fiber optic transmission systems, signals are transmitted along lengths of optical fiber by light waves generated from a source, such as a laser. Optical fiber is typically fabricated of glass and is very delicate or fragile. An optical fiber may be on the order of 125 microns in diameter or smaller.

In some fiber optic transmission systems, lengths of fiber optic cables or “drops” must be installed through ducts, conduits, or the like. For example, when providing service to individual units in a multi-unit dwelling (e.g., an apartment building), a fiber drop must be placed at each individual unit in the multi-unit dwelling. This is typically accomplished by placing a conduit or duct from a central service provision location to a predetermined location in each individual unit that happens to be served by that location. The duct may be placed at either the time of the initial construction or at any time prior to placement of a service order. Placement of the duct facilitates subsequent service installation without requiring significant construction time or personnel.

Regardless of the time at which the duct is installed, prior to initiating service to a particular unit, a fiber optic drop is placed within the duct from the terminal to the particular unit. Typical fiber drop installation procedures require multiple personnel, to ensure that an adequate length of optical fiber is provided to the unit.

### BRIEF DESCRIPTION OF THE DRAWINGS

FIG. 1 is a block diagram illustrating an exemplary application environment in which devices and methods described herein may be implemented;

FIGS. 2A and 2B are schematic diagrams illustrating an exemplary implementation of a fiber drop stop assembly consistent with embodiments described herein;

FIGS. 3A and 3B are cross-sectional and axial schematic diagrams, respectively, of an exemplary implementation of the housing of FIGS. 2A and 2B;

FIGS. 4A-4C are cross-sectional, axial, and isometric schematic diagrams, respectively, of an exemplary embodiment of the fiber drop stop of FIGS. 2A and 2B; and

FIG. 5 is a flow diagram illustrating exemplary processing for installing a fiber drop in the application environment of FIG. 1 using the fiber drop stop assembly of FIG. 2A.

### DETAILED DESCRIPTION OF PREFERRED EMBODIMENTS

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Devices and methods consistent with aspects described herein provide for efficient installation of lengths of optical fibers within installation conduits. More specifically, an assembly may be provided for enabling accurate feed-through of a predetermined length of optical fiber through a conduit. A fiber drop stop element may be positioned along a length of optical fiber. A fiber drop stop assembly may engage the stop element and prevent additional optical fiber from being passed through the conduit.

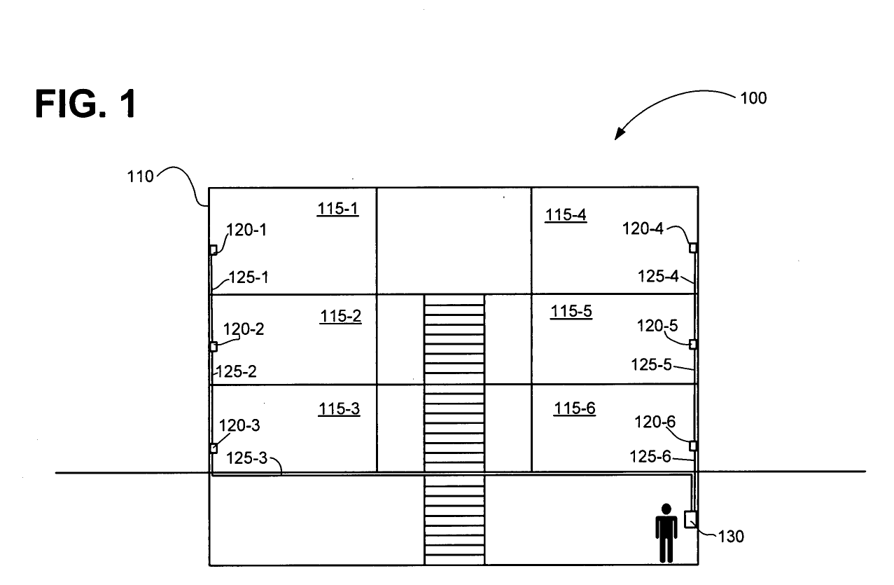

FIG. 1 is a block diagram illustrating an exemplary application environment 100 in which devices and methods described herein may be implemented. As illustrated, application environment 100 may include a multi-unit building 110, units 115-1 to 115-6, drop entry points 120-1 to 120-6, conduits 125-1 to 125-6, and a service provision location 130.

Multi-unit building 110 may include a physical structure, such as an apartment building, an office building, etc., having a number of individual units 115-1 through 115-6 (collectively “units 115” or individually “unit 115”) provided therein. As described above, each unit 115 may be provided with a corresponding drop entry point 120-1 to 120-6 (collectively “drop entry points 120” or individually “drop entry point 120”) for receiving a fiber drop. For example, a utility room or utility closet in unit 115 may be provided with drop entry point 120.

In some embodiments, drop entry point 120 may include a device or port capable of receiving a fiber drop. Further, in some implementations, drop entry point 120 may be provided or installed during initial construction of multi-unit building 110 or may be provided during provision of fiber-based services to a particular unit 120 in multi-unit building 110.

Each drop entry point 120 may be serviced by a corresponding conduit 125-1 to 125-6 (collectively “conduits 125” or individually “conduit 125”) for facilitating delivery of a fiber drop from service provision location 130 to each unit 115. As illustrated, depending on a location of unit 115 relative to service provision location 130, conduits 125 may extend hundreds of feet in length and may include multiple bends.

In some implementations, service provision location 130 may be provided in a centralized location relative to units 115. Alternatively, service provision location 130 may be provided at a common building access point for building service providers, such as a basement or utility room(s). In yet other implementations, multiple service provision locations 130 may be provided for selected ones of units 115, such as a first service provision location for a first group of units and a second service provision location for a second group of units.

A single multi-unit building 110, six units 115, six drop entry points 120, six conduits 125, and a single service provision location 130 have been illustrated in FIG. 1 for simplicity. In practice, there may be more or less multi-unit buildings, units, drop entry points, conduits, and service provision locations.

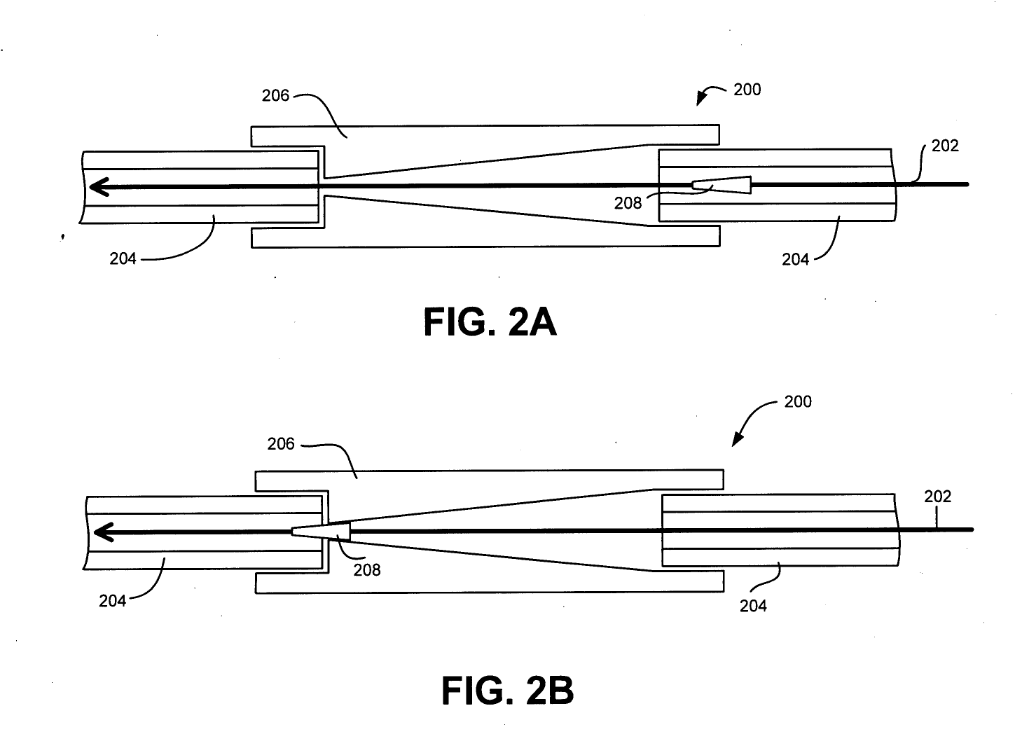

FIGS. 2A and 2B are schematic diagrams illustrating an exemplary implementation of a fiber drop stop assembly 200 consistent with embodiments described herein. In the embodiment of FIGS. 2A and 2B, fiber drop stop assembly 200 may facilitate efficient installation of a fiber drop 202 within conduit 125. In one exemplary implementation, conduit 125 may include a microduct 204 having an outside diameter of ranging from approximately 8.5 millimeters (mm) to 12.7 mm. Exemplary optical fibers may have outside diameters of approximately 2 mm to 7 mm. It should be understood that other conduit sizes and fiber sizes may be used in other implementations.

Fiber drop stop assembly 200 may include a housing 206 and a fiber drop stop 208. Housing 206 may be configured to receive fiber drop 202 from microduct 204. For example, in one implementation, housing 206 may be provided at drop entry point 120-1 in building 110 and may receive fiber drop 202 from service provision location 130 via microduct 204 provided within conduit 125-1. In some implementations, housing 206 may be a portable device that may be carried from location to location within building 110. In other implementations, housing 206 may be connected to, or integrated with, a device for receiving a length of fiber drop, such as the fiber drop receiving device described in U.S. Pat. No. 7,447,413, assigned to the assignee of the present application, the entirety of which is incorporated by reference herein. In other implementations, housing 206 may be integrated into or connected to conduit 125 in building 110. Housing 206 may be formed of any suitable material, such as plastic, rubber, metal, wood, etc., or combinations of materials.

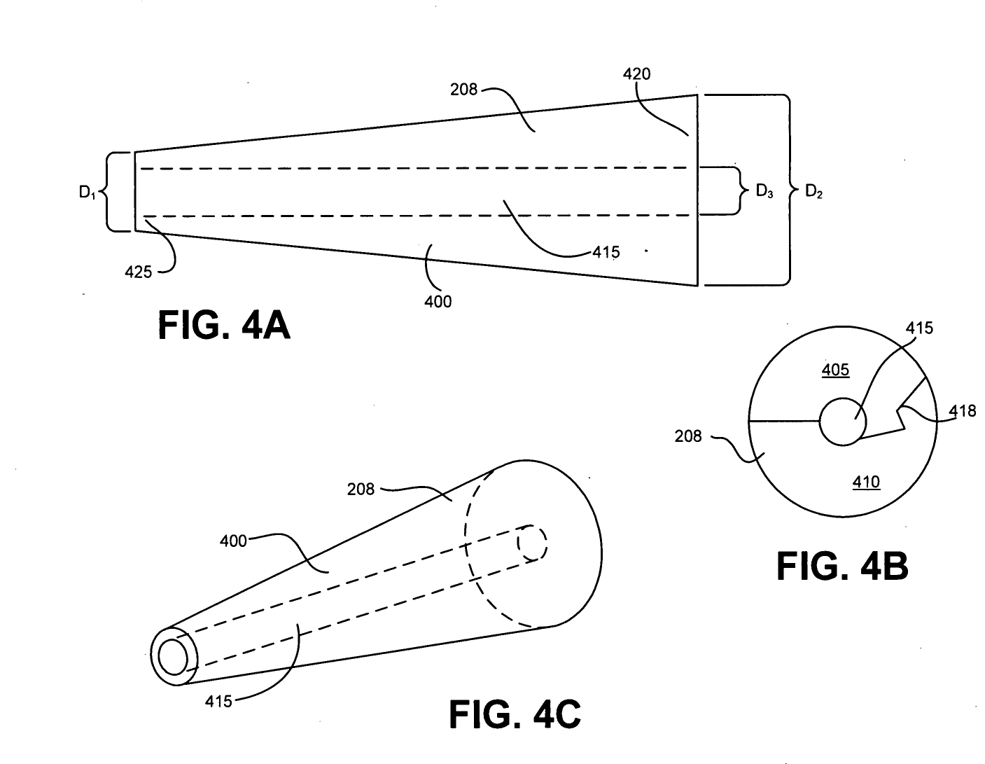

As will be described in additional detail below, housing 206 may include one or more interior cavities configured to reduce from a first diameter to a second diameter, for engaging fiber drop stop 208, while enabling the passage of fiber drop 202. As shown in FIGS. 2A and 2B, fiber drop stop 208 may be a substantially conical device configured to affix at a predetermined location along a length of fiber drop 202. A maximum outside diameter of fiber drop stop 208 may be configured to engage the reduced inside diameter of housing 206. Additional details regarding the configuration of fiber drop stop 208 are set forth below, in relation to FIGS. 4A-4C.

In operation, an installation technician may determine that a predetermined length of “extra” fiber drop 202 is desired at a drop entry point (e.g., 120-1) in a structure (e.g., multi-unit building 110). The length of drop is “extra” in the sense that it is in addition to the length of drop necessary to reach the drop entry point from the service provisioning location 130. For example, in one embodiment, 5 feet of “extra” or slack fiber drop 202 may be desired.

To facilitate stoppage of fiber drop 202 following provisioning of the desired length of fiber, fiber drop stop 208 may be affixed or attached to fiber drop 202 at a distance from the end of fiber drop 202 being fed or otherwise passed through microduct 204. For instance, in the example above in which five feet of slack is desired, fiber drop stop 208 may be positioned five feet from the end of fiber drop 202. As shown in additional detail below in reference to FIGS. 4A-4C, in one exemplary implementation, fiber drop stop 208 may include a substantially conical structure configured to surround and attach to fiber drop 202 at a predetermined location. The conical shape of fiber drop stop 208 may engage an inside surface of housing 206, as illustrated in FIG. 2B, thereby inhibiting advancement of fiber drop stop 208 within housing 206.

Although FIGS. 2A, 2B, and 4A-4C depict fiber drop stop 208 as having a conical configuration, it should be understood that fiber drop stop 208 may be configured in any suitable shape, such that progression of fiber drop stop 208 beyond housing 206 is inhibited, thereby providing an installation technician with an accurate mechanism for determining a length of available fiber at an installation location.

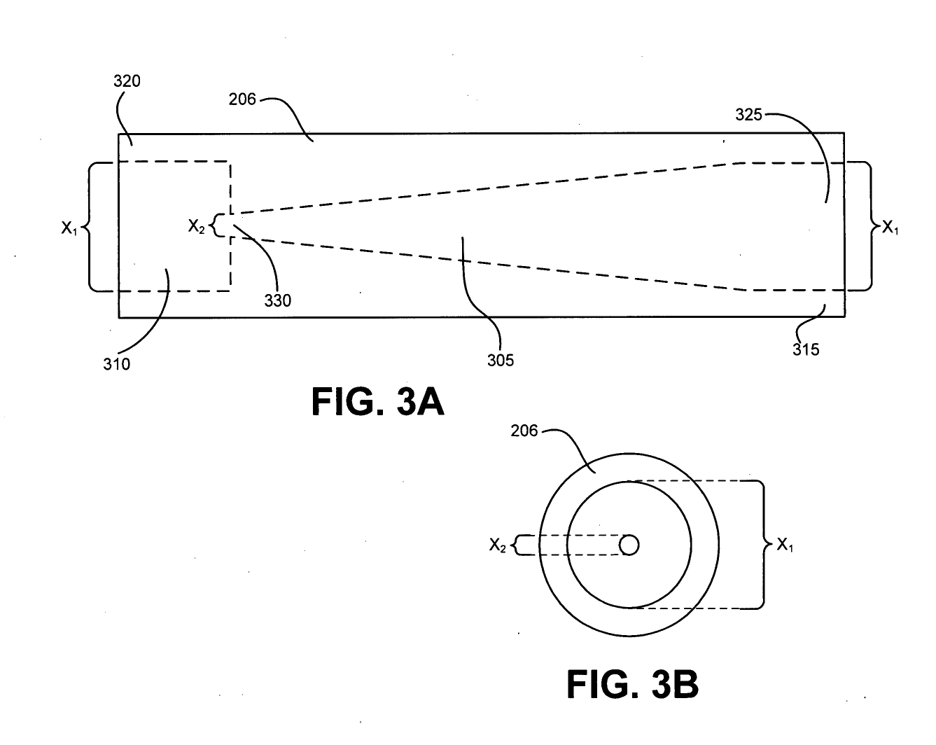

FIGS. 3A and 3B are cross-sectional and axial schematic diagrams of an exemplary implementation of housing 206, respectively. As illustrated in FIG. 3A, in one exemplary implementation, housing 206 may have a substantially cylindrical configuration having a first cavity 305 and a second cavity 310. First cavity 305 may be provided at a drop receiving end 315 of housing 206 and may be sized such that a microduct (e.g., microduct 204) may be received therein. Second cavity 310 may be provided at a downstream end 320 of housing 206. In one exemplary embodiment, downstream end 320 of housing 206 may be configured to attach to a fiber receiving device or, alternatively, an additional length of microduct.

First cavity 305 may have a substantially conical or funnel-like shape, reducing in size from a first end 325 having a diameter X₁ substantially equal to an outside diameter of the received microduct (e.g., microduct 204), to a second end 330 having a diameter X₂ smaller than diameter X₁ and also smaller than an outside diameter of fiber drop stop 208, described in additional detail below.

Second end 330 of first cavity 305 may open to second cavity 310, thereby enabling a received fiber drop 202 to pass from first cavity 305 to second cavity 310. In one exemplary implementation, second cavity 310 may have diameter X₁ and may receive another length of microduct. In other implementations, second cavity 310 may interact with a downstream fiber drop receiving device, such as the fiber drop receiving device described in U.S. Pat. No. 7,447,413. For example, second cavity 310 may be directly connected or coupled to a fiber receiving device.

Consistent with embodiments described herein, housing 206 may be further configured to receive a flow of pressurized air from within microduct 204. The flow of pressurized air may facilitate movement of fiber drop 202 within microduct 204. Similarly, the flow of pressurized air may facilitate movement of fiber drop 202 within housing 206. One exemplary device for introducing a flow of pressurized air into microduct 204 is described in U.S. patent application Ser. No. 11/966,628, entitled “Fiber Drop Installation Device,” assigned to the assignee of the present application, the entirety of which is incorporated by reference herein.

FIGS. 4A-4C are cross-sectional, axial, and isometric schematic diagrams, respectively, of an exemplary embodiment of fiber drop stop 208. As illustrated in FIGS. 4A-4C, in one exemplary implementation, fiber drop stop 208 may have a substantially conical body 400 having a first portion 405 and a second portion 410 and a center cavity 415 extending axially therethrough. More specifically, body 400 may include a first end 420 having an outside diameter D₂ and a second end 425 having an outside diameter D₁. As illustrated diameter D₂ may be larger than diameter D₁ and, furthermore, may be larger than diameter X₂ in housing 206. In this manner, body 400 of fiber drop stop 208 may engage housing 206 of fiber drop stop assembly 200 to inhibit or limit movement of fiber drop stop 208 within housing 206.

Center cavity 415 may include an inside diameter D₃ substantially similar to or slightly smaller than an outside diameter of fiber drop 202, such that fiber drop stop 208 may be securely affixed to fiber drop 202 via center cavity 415. As illustrated in FIG. 4B, in one exemplary embodiment, first portion 405 and second portion 410 may snap-engage each other about center cavity 415, as illustrated by line 418. For example, the shape of the portions of first portion 405 and second portion 410 that engage each other may be configured to snap together securely about fiber drop 202. In one embodiment, first portion 405 may be hingedly attached to second portion 410. In alternative implementations, first portion 405 and second portion 410 may be securely adhered to each other in other ways, such as adhesives, or mechanical fasteners, such as screws, clips, etc. In yet other implementations, fiber drop stop 208 may include a material, such as tape, etc. affixed to or wrapped around fiber drop 202 to increase the diameter of fiber drop 202 to a diameter (e.g., D₂) larger than inside diameter X₂ of housing 206.

Although fiber drop stop assembly 200 has been illustrated as including a variety of components, structures, and/or configurations, it should be understood that these components and structures are not limiting and that any suitable combination of components and/or structures may be used.

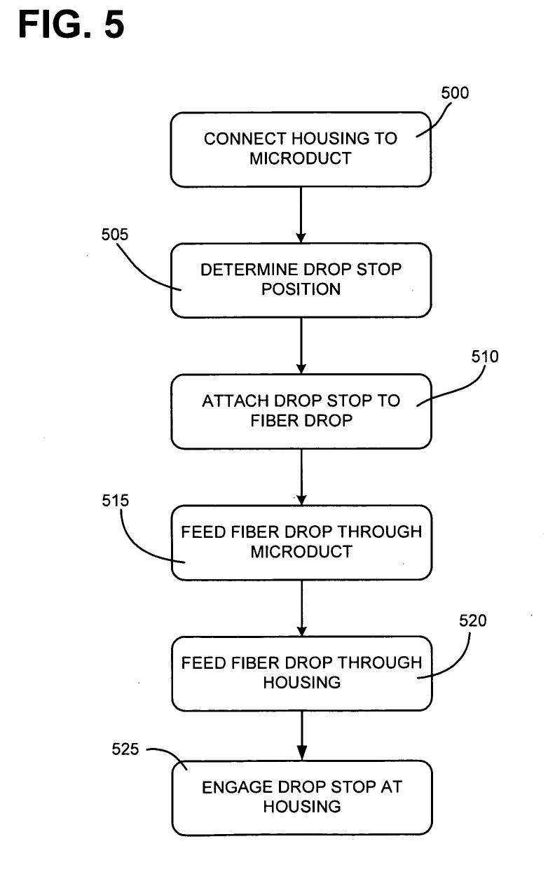

FIG. 5 is a flow diagram illustrating exemplary processing for installing a fiber drop in the application environment of FIG. 1 using the fiber drop stop assembly of FIG. 2A. The process may begin at a drop entry point (e.g., drop entry point 120-1), with housing 206 being connected to microduct 204 residing in a conduit (e.g., conduit 125-1) (block 500).

In a service provisioning location 130 (distant from the drop entry point), a length of fiber drop 202 may be measured to determine a location for fiber drop stop 208 (block 505). For example, a length of fiber may be measured in service provisioning location 130 of multi-unit building 100. Fiber drop stop 208 may be affixed or attached to fiber drop 202 at the position determined in block 505 (block 510). For example, as described above, first and second portions 405/410 of fiber drop stop 208 may be snapped together over fiber drop 202.

Fiber drop 202, including fiber drop stop 208, may be fed or propelled through microduct 204 (block 515). For example, a fiber installation device may be used to propel fiber drop 202 through microduct 204 using a flow of pressurized air and a mechanical feeding assembly. One exemplary fiber installation device is described in U.S. patent application Ser. No. 11/966,628, and entitled “Fiber Drop Installation Device.”

Fiber drop 202 may be fed through housing 206 at the drop entry point (block 520). Fiber drop stop 208 may engage housing 206, thereby prevent further travel of fiber drop 202 within microduct 204 (block 525). The measured position of fiber drop stop 208 ensures that a desired length of fiber drop 202 is available at the drop entry point, without requiring the presence of a technician to receive the drop.

Implementations consistent with aspects described herein provide an efficient mechanism for ensuring that a suitable and desired length of optical fiber is provided at a drop entry point, without requiring multiple personnel to perform the task of fiber provisioning. More specifically, a housing may be provided to receive the fiber drop at the drop entry point. A fiber drop stop element may be positioned on the fiber drop at a position corresponding to the desired length of fiber drop. Upon passage through a conduit from the service provisioning location to the drop entry point, the drop stop element may engage the housing to prevent further advancement of the fiber drop through the housing.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, although a funnel-like structure has been described above with respect to housing 206, other suitable structures may be used, such as angled surfaces, textured surfaces, etc. In addition, although a conical shape has been described above with respect to fiber drop stop 208, additional shapes or configurations may be used. For example, a spherical, or oblong structure or configuration may be used.

While a series of blocks have been described with regard to FIG. 5, the order of the blocks may be modified in other implementations. Further, non-dependent blocks may represent blocks that can be performed in parallel. For example, blocks 500, 505, and 510 may be performed in parallel or in any suitable order.

No element, block, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. In combination:
a device for receiving a fiber optic drop fed thereto; and
a drop stop element configured to attach to the fiber optic drop at a particular position,
wherein the device is configured to engage the drop stop element to inhibit feeding of additional fiber optic drop to the device.

2. The combination of claim 1, wherein the device comprises a funnel-like structure configured to receive the fiber optic drop.

3. The combination of claim 2, wherein the device comprises a first opening having a first diameter and a second opening having a second diameter, wherein the second diameter is smaller than a maximum diameter of the drop stop element.

4. The combination of claim 1, wherein the device comprises a substantially cylindrical housing.

5. The combination of claim 1, wherein the device comprises a first cavity having a substantially conical shape that reduces in size from a first end having a first diameter, to a second end having a second diameter, wherein the second diameter is smaller than a maximum diameter of the drop stop element.

6. The combination of claim 5, wherein the first diameter is substantially similar to an outside diameter of a conduit that carries the fiber optic drop.

7. The combination of claim 6, wherein the conduit comprises a microduct.

8. The combination of claim 5, wherein the device comprises a second cavity connected to the first cavity at the second end, wherein the second cavity is configured to connect to a fiber receiving device.

9. The combination of claim 1, wherein the drop stop element comprises a substantially conical structure.

10. The combination of claim 9, wherein the drop stop element comprises a first portion and a second portion that couple together around the fiber optic drop at the particular position.

11. The combination of claim 10, wherein the first portion and the second portion snap together.

12. A device, comprising:
a housing having a cavity provided axially therein,
wherein the housing is configured to receive a fiber optic drop having a drop stop element affixed thereto, the drop stop element having a maximum diameter larger than a diameter of the fiber optic drop;
wherein the cavity has a first opening and a second opening, the first opening having a diameter larger than the maximum diameter of the drop stop element, and the second opening having a diameter smaller than the maximum diameter of the drop stop element.

13. The device of claim 12, wherein the cavity comprises a substantially conical shape.

14. The device of claim 12, wherein the housing comprises a substantially cylindrical housing.

15. The device of claim 12, wherein the first opening is configured to receive a conduit for carrying the fiber optic drop.

16. The device of claim 12, wherein the drop stop element comprises a first portion and a second portion that couple together around the fiber optic drop at the particular position.

17. The device of claim 16, wherein the drop stop element comprises a substantially conical shape.

18. A method for receiving a fiber drop, comprising:
connecting a device for receiving the fiber drop to a conduit at a drop entry point;
determining a position for affixing a drop stop element to the fiber drop;
attaching the drop stop element to the fiber drop at the position;
feeding the fiber drop, including the drop stop element, into the conduit at a service provisioning location;
receiving the fiber drop by the device; and
engaging the drop stop element by the device to inhibit feeding of additional fiber drop.

19. The method of claim 18, wherein the device comprises a housing having a funnel-like structure configured to receive the fiber optic drop,
wherein the housing includes a first opening having a first diameter and a second opening having a second diameter, wherein the second diameter is smaller than a maximum diameter of the drop stop element.

20. The method of claim 18, wherein the drop stop element comprises a first portion and a second portion that couple together to fixedly attach to the fiber drop at the particular position.
